(19) United States
(12) Patent Application Publication
(10) Pub. No.: US 2017/0321836 A1
(43) Pub. Date: Nov. 9, 2017

(54) INTEGRATED FLUSH-FACE CARTRIDGE

(71) Applicant: Faster S.P.A., Rivolta D'Adda (IT)

(72) Inventors: Alessandro Danelli, Brignano Gera D'Adda (IT); Roberto Sorbi, Rivolta D'Adda (IT)

(21) Appl. No.: 15/588,367

(22) Filed: May 5, 2017

(30) Foreign Application Priority Data
May 9, 2016 (EP) 16168737.1

(51) Int. Cl. F16L 37/36; F16L 37/12; F16L 37/34; F16L 37/23; F16L 37/33; F16K 25/00

(52) U.S. Cl. CPC F16L 37/36; F16L 37/34; F16L 37/23; F16L 37/12; F16K 25/00; F16L 37/33

(57) ABSTRACT

The present invention relates to a female cartridge coupling of the type suitable for being inserted into a support block, or manifold, which is connectable to a pressurized oil circuit on board the machine.

The female cartridge coupling in accordance with the present invention is characterized in that although it is configured to be inserted into a support block, it is suitable for being connected to Standard ISO 16028-compliant flush-face male couplings.

The cartridge in accordance with the present invention further comprises a system for mechanically locking the decompression valve which allows the connection of a male coupling.

### CROSS REFERENCE TO RELATED APPLICATION(S)

The present application claims priority to European Patent Application No. 16168737.1 filed May 9, 2016, the entirety of the disclosures of which are expressly incorporated herein by reference.

### STATEMENT RE: FEDERALLY SPONSORED RESEARCH/DEVELOPMENT

Not Applicable.

### FIELD OF THE INVENTION

The present invention relates to a quick cartridge coupling, that is of the type suitable for being inserted into a support block which may house a plurality of quick couplings.

More specifically, cartridge couplings of the type considered herein, as mentioned, intended to be inserted into a support block, are generally female couplings which may be interfaced with Standard ISO 7241-compliant male couplings commonly used in the agricultural field.

The present invention relates to a quick cartridge coupling, more specifically to a female coupling, suitable for being inserted into a support block, or “manifold”, and which allows the connection of Standard ISO 16028-compliant male couplings, known in the field as flush-face couplings.

### BACKGROUND ART

Systems are known in the field, which allow the manual coupling between a support block, also called “manifold”, which generally houses a plurality of female cartridge couplings, and one or more hydraulic lines, provided with corresponding male couplings of the type suitable for being connected to said female cartridges.

Standard ISO 7241 is the reference standard for cartridge couplings employed in the agricultural field. Such a standard establishes certain dimensional and functional parameters of the coupling.

Female couplings of the type considered herein are called “cartridge” couplings because the operation thereof requires them to be completely integrated in the seat specifically provided inside a support block, or manifold, and this is because the flow of oil occurs in a non-axial manner with respect to the coupling, and therefore the support block is involved in the flow itself.

More specifically, the axial flow from the male coupling axially flows into the female cartridge coupling and is then diverted radially to be directed by a channel specifically provided in the manifold.

Generally, a lever which can be operated manually by the operator to decompress any residual pressure in the couplings is provided on blocks or manifolds of type known from the background art. Cartridges indeed generally comprise a decompression system, in turn comprising actuation means arranged at the back of the coupling, that is in the opposite area with respect to the front area for connecting the coupling itself, in accordance with that known from the background art.

As mentioned, a limitation affecting known solutions consists of the fact that cartridges suitable for being supported by a block or manifold only allow the connection with Standard ISO 7241-compliant male couplings due to the structure thereof.

Known cartridges, and the related blocks, therefore do not consist of a versatile system.

### SUMMARY

It is the object of the present invention to overcome the versatility limitations of systems known from the background art.

Within the scope of such a task, it is the object of the present invention to provide a device adapted to being inserted into a support block or manifold, which allows the connection of hydraulic lines with flush-face male couplings, that is Standard ISO 16028-compliant.

It is also the object of the present invention to provide a female cartridge coupling of the type which can be inserted into a support block or manifold and capable of being coupled to a flush-face male coupling.

It is also the object of the present invention to provide a female cartridge coupling, which although it is of the type which can be inserted into a flush-face male coupling, has the following functionalities:
the push-pull connection system;
the break-away functionality;
it can also be coupled in the presence of residual pressure on the cartridge side;
it can be coupled with any type of Standard ISO 16028-compliant male, as long as it is provided with a pressure discharge system on the male side;
mechanical lock of the cartridge value during the connection step;
system for releasing the mechanical lock which allows keeping a given residual pressure in the male part in the event of disconnection in the presence of residual pressure in the cartridge.

This task and these and other objects which will become more apparent hereinafter are achieved by a female cartridge coupling according to the appended claims, which form an integral part of the present description.

### LIST OF THE DRAWINGS

Further features and advantages of the present invention will become more apparent from the following detailed description, provided by way of non-limiting example and illustrated in the accompanying drawings, in which:

FIG. 1 shows a perspective assembly view of the support block in which two female cartridge couplings in accordance with the present invention, are inserted;

FIG. 2 shows a perspective view of a Standard ISO 16028-compliant flush-face male coupling;

FIG. 3 shows the block in FIG. 1 in a longitudinal sectional view with a vertical plane passing through the axis of one of the cartridge couplings;

FIG. 4 shows the sectional view in FIG. 3, in which a flush-face male coupling is depicted with pressurized fluid;

FIG. 5 shows the same sectional view in FIG. 4, in a first coupling step of the male coupling to the female coupling;

FIG. 6 shows the same view in FIG. 5, in a successive step of inserting the male into the female cartridge;

FIG. 7 shows the same view in FIG. 5, in a successive step of inserting the male into the female cartridge, in which the outer slider of the male coupling pushes the inner slider of the cartridge;

FIGS. 8 to 15 show successive connection steps of the male coupling with the female cartridge;

FIG. 16 shows a perspective view of the pusher of the female cartridge;

FIGS. 17 to 27 show the steps of disconnecting the male coupling from the female cartridge in accordance with the present invention;

FIGS. 28 to 30 show three-dimensional sectional views of the interface area between lever, pusher and mechanically locking slider of the cartridge in accordance with the present invention;

FIG. 31 shows a perspective non-sectional view of the interface area between lever, pusher and mechanically locking slider of the cartridge in accordance with the present invention.

### DETAILED DESCRIPTION OF THE INVENTION

The following description will disclose a preferred embodiment of the flush-face cartridge in accordance with the present invention.

Such a description is provided by way of non-limiting example, thus all variants of the described elements which may be considered equivalent are to be considered as falling within the scope of the present invention.

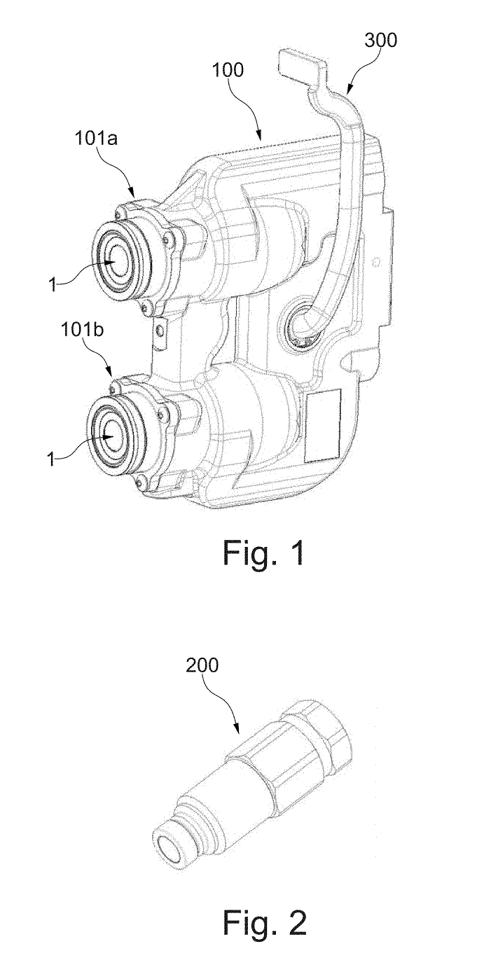

With particular reference to FIG. 1, a support block or manifold 100 of the type considered herein generally consists of a block made of cast iron or similar metal material, and is provided with at least one seat therein, in the embodiment two seats 101a, 101b configured to each house a flush-face cartridge 1 in accordance with the present invention.

Cartridge 1 in accordance with the present invention allows to obtain all the functionalities of traditional cartridges employed in the agricultural field, with the uniqueness of being couplable with Standard ISO 16028-compliant male couplings, shown for example in FIG. 2 and indicated with numeral 200.

Among such functionalities, cartridge 1 in accordance with the present invention is equipped with a push-pull connection system, safety break-away disconnection system, allows coupling in the presence of residual pressure, allows coupling with pressurized male couplings if provided with pressure discharge systems, is equipped with mechanical lock of the valves in the open position.

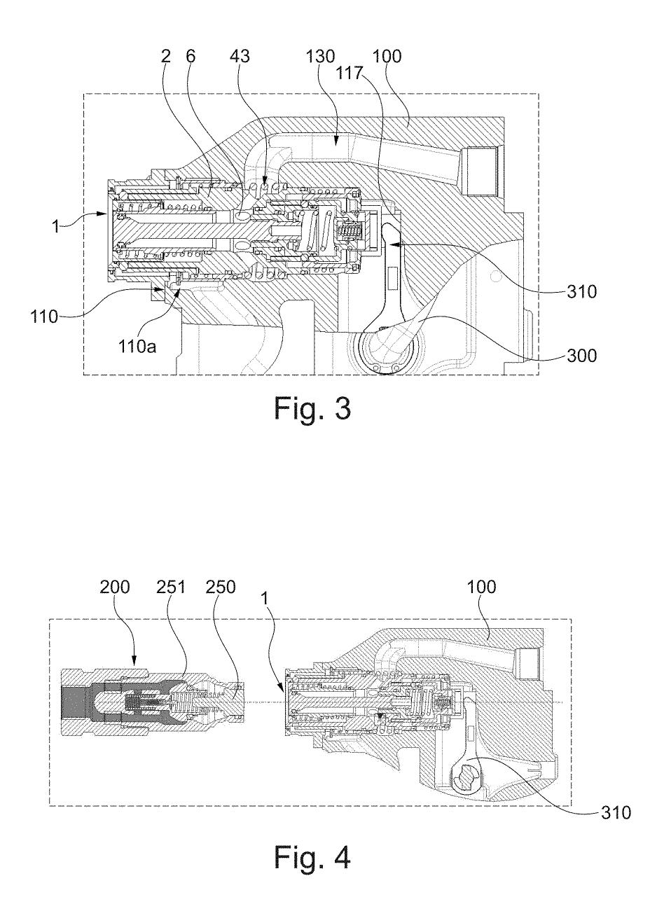

Returning to the accompanying drawings, FIG. 3 shows a sectional view of the support block 100 in which the female hydraulic couplings are assembled with cartridge 1 in accordance with the present invention. It is worth noting cam 310, which is connected to the disconnecting lever 300 shown in FIG. 1 and the rear surface 117 of block 100, opposite to the front surface 110 from which the cartridges 1 overlook, which is required for the interface with the hydraulic system of the manufacturing machine on which block 100 is installed.

Again with reference to FIG. 3 in which a sectional detail is shown of block 100 with a vertical longitudinal plane passing through the axis of a coupling with cartridge 1, when said coupling with cartridge 1 is inserted into block 100, the front part of the coupling faces outwardly from the front surface 110 of block 100, while the rear part of coupling 1 is close to the cam 310 of lever 300.

The operating fluid, in particular consisting of oil, originating from the hydraulic circuit on the machine, is directed to cartridge 1 through conduits 130. More specifically, substantially radial holes 6 for inletting the oil are specifically provided on the ball body 2 of said female cartridge 1.

One of the features of the female cartridge 1 in accordance with the present invention consists of the possibility of being connected both when there is no pressure and when there is residual internal pressure, and both when the male coupling is discharged and when there is residual pressure in the male coupling.

To obtain this technical result, cartridge 1 in accordance with the present invention has particular construction features.

As mentioned, the flush-face cartridge 1 comprises a substantially cylindrical shaped ball body 2.

Advantageously, a flange 1a may be provided as protection against dirt, the cartridge being locked in the seat of the manifold by the elastic ring 40.

A ring nut slider 4, it also having cylindrical symmetry, cooperates with said ball body 2, which is arranged inwardly with respect to said ring nut slider 4, and with a ring of locking balls 3 housed in a corresponding seat obtained on said ball body 2.

The locking ball ring 3 is kept in the expanded position with female coupling disconnected, by an outer slider 5, while it is radially movable during the coupling step with the male coupling 200 according to that known from the background art.

The female coupling 1 further comprises an axially movable inner slider 7 and an axial valve body 8, a helical spring 42 arranged between said inner slider 7 and said ball body 2 being configured to counter the sliding of said inner slider 7 with respect to said ball body 2. With reference for example to FIG. 6, the valve body 8 comprises a front end 8a designed to come into contact with the front end of the corresponding valve body of a male coupling 200, and a rear end 8b to which a substantially cylindrical shaped inner body 9 is connected, preferably by screwing, and in which said rear end 8b is at least partly inserted.

The outer surface of said inner body 9 has at least one circumferential seat 10 for housing mechanical locking balls 11 of the decompression system of cartridge 1.

Said mechanical locking balls 11 of the decompression system are in turn inserted into a series of radial holes 12a specifically provided on the rear body 12, which also has a substantially cylindrical shaped end in which said inner body 9 is at least partly inserted.

Advantageously, a rear slider 13 is slidingly associated with said rear body 12 and is configured to cooperate with said mechanical locking balls 11. The rear slider 13 is constrained to a rear abutment 14, it also configured as a substantially cylindrical body which projects at the back from the cartridge and is connected to said rear slider 13 by means of an elastic ring 15, and is movable between a first position in which it keeps the locking balls 11 in a circumferential seat 10 of said inner body 9, and a second position in which it leaves said locking balls 11 free to radially expand, thus disengaging the inner body 9.

There are formed inside said rear body 12 and said inner body 9 a decompression chamber 25 and a seat 26 for housing a decompression valve housing a decompression valve 33, the operation of which is described below.

Such an assembly of components, that is the rear slider 13 and the rear abutment 14, is kept in the withdrawn position, that is toward the rear part of the cartridge, by the action of the helical spring 16, up to said rear abutment 14 coming into contact with the cam 310 of lever 300.

Cam 310 is in turn resting at the back against the inner surface 117 of block 100.

The rear slider 13, the rear abutment 14 and the elastic ring 15 are therefore locked in the most withdrawn position thereof by the action of the elastic spring 16 and by the abutment against cam 310.

The valve body 8, the inner body 9 to which the rear end 8b of said valve body is connected, and the rear body 12 are in turn locked in the most advanced position thereof, due to the mechanical locking balls 11 of the decompression system of cartridge 1.

Such a system is called “mechanical lock” because, as shown for example in FIG. 6, when a male coupling 200 is pushed toward the female coupling, there is a step in which the valve body 250 of the male coupling 200 tends to push the valve body 8 of the female cartridge 1 into the withdrawn position.

The assembly of components comprising the valve body 8, the inner body 9, the rear body 12 which supports said seat 26 of said decompression valve 33, rear slider 13, with the related mechanical locking balls 11 of the decompression system, remains locked in the advanced position with respect to the ball body, thus opening the valve of the male coupling.

The operation of cartridge 1 will now be illustrated using various hypotheses so as to clarify the components and functionality of the integrated flush-face cartridge in accordance with the present invention.

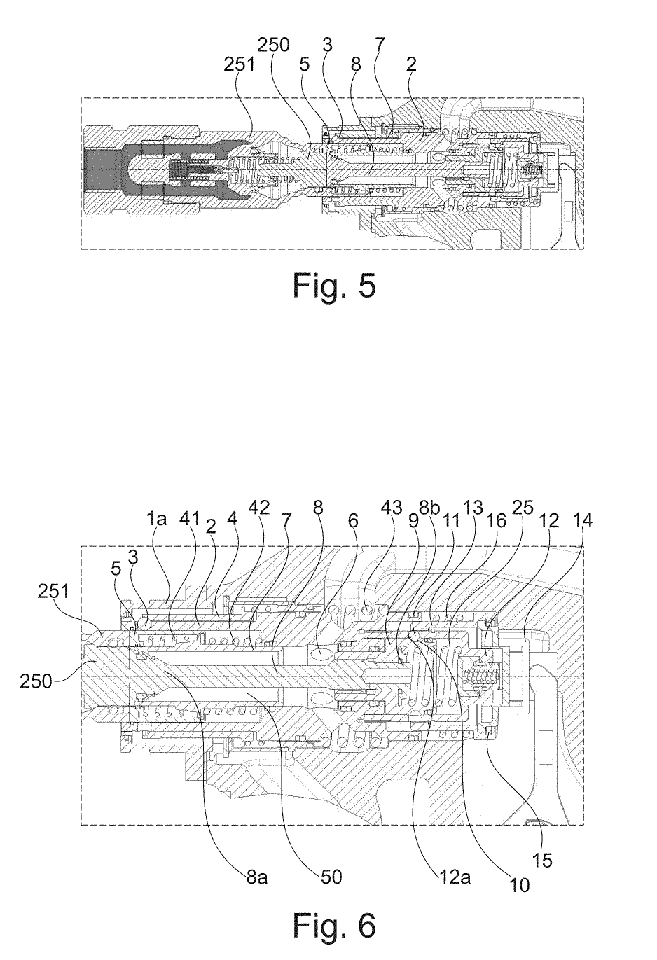

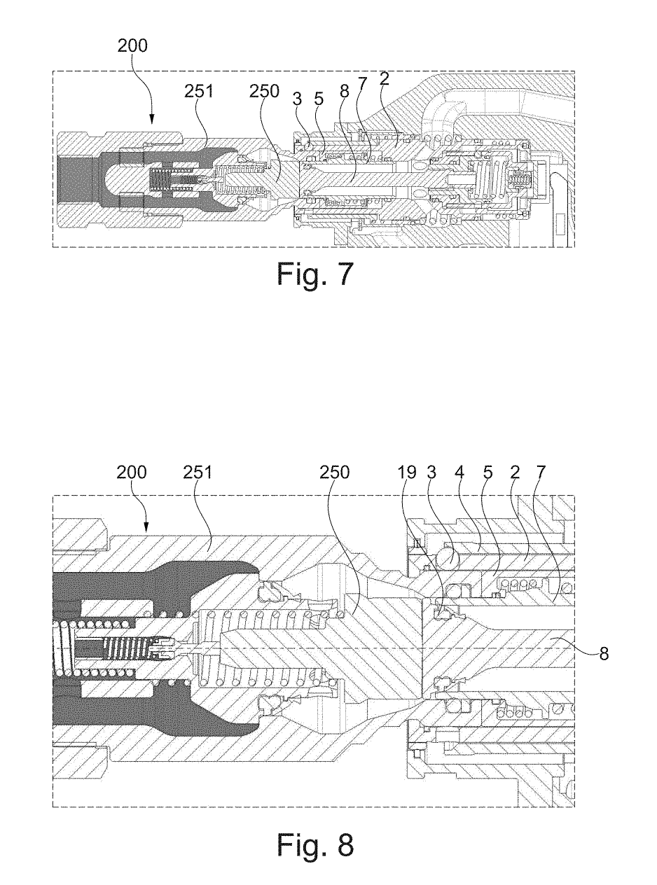

With particular reference to FIG. 5, when male coupling 200 and flush-face female cartridge 1 come into contact, the valve body 250 of the male coupling 200 comes into contact with the valve body 8 of the female cartridge 1 at the front, and the outer body 251 of the male coupling simultaneously comes into contact with the outer slider 5 at the front.

With reference to FIG. 6, proceeding in the step of coupling the male coupling 200 to the female cartridge 1, there is a step in which the valve body 250 of the male coupling pushes the valve body 8 of the female cartridge into the withdrawn position.

As already described above, the clearances of the mechanical locking system are eliminated in this step, that is the mechanical locking balls 11 housed in the circumferential seat 10 conveniently provided in said inner body 9 are inserted into said radial holes 12a specifically provided on the rear body 12, and are kept in interference with said radial holes 12a by said rear slider 13.

The mechanical locking circumstance is the one described above with reference to FIG. 6.

Continuing in the connection step, the main body 251 of the male coupling pushes the outer slider 5 at the back until the outer slider 5, opposing the action of a helical spring 41 provided between said outer slider 5 and said inner slider 7, comes into contact with the inner slider 7, thus inducing the withdrawal which counters the action of spring 42, which acts between said inner slider 7 and said ball body 2.

With reference to FIG. 8, continuing with the connection step, the inner slider 7 is caused to withdraw up to revealing gasket 19 at the front of the valve body 8 of cartridge 1.

Therefore, the valve body 8 of cartridge 1 has not withdrawn in this step, while the main body 251 of the male coupling advances toward the cartridge. This results in a related movement of the valve body 250 of the male coupling, which comes into contact with the micro decompression valve 252 provided on the male coupling 200, by opening it.

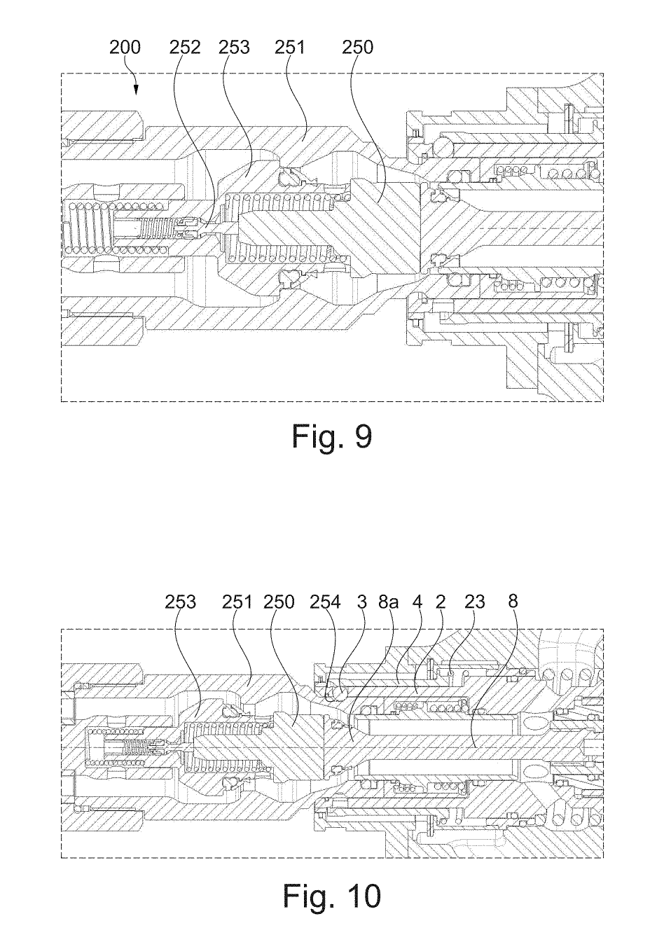

With reference to FIG. 9, proceeding in the connection step of the male coupling 200 to the female cartridge 1, the valve body 250 of the male coupling pushes the valve body 252 of the female cartridge into the withdrawn position, thus discharging the residual pressure in the rear chamber of the male coupling. In this step, the valve body 250 of the male coupling comes into contact with an inner valve 253 of the male coupling.

With reference to FIG. 10, in the last connection step, the main body 251 of the male coupling 200 is further inserted into the female cartridge 1, thus pushing the outer slider 5 and the inner slider 7 into the withdrawn position.

The valve body 250 of the male coupling simultaneously pushes the inner valve 253 of the male coupling 200 into the withdrawn position, thus opening the passageway of the oil flow in the male coupling.

In this step, the locking balls 3 housed in a corresponding seat obtained on said ball body 2 are inserted into a circumferential locking groove 254 obtained on the outer surface by the main body 251 of the male coupling 200, thus locking the male coupling 200 in the female cartridge 1. The helical spring 23 pushes the ring nut slider 4, which keeps the locking balls 3 engaged in the circumferential locking groove 254.

The connection steps described hereto do not vary even when considering the connection of a male coupling 200 in which there is no pressurized fluid. With cartridge 1 in accordance with the present invention, it is also possible to connect a male coupling with no residual pressure discharge system, that is without the micro decompression valve 252 and the inner valve 253 of the male coupling, on the condition that the male coupling is thus discharged.

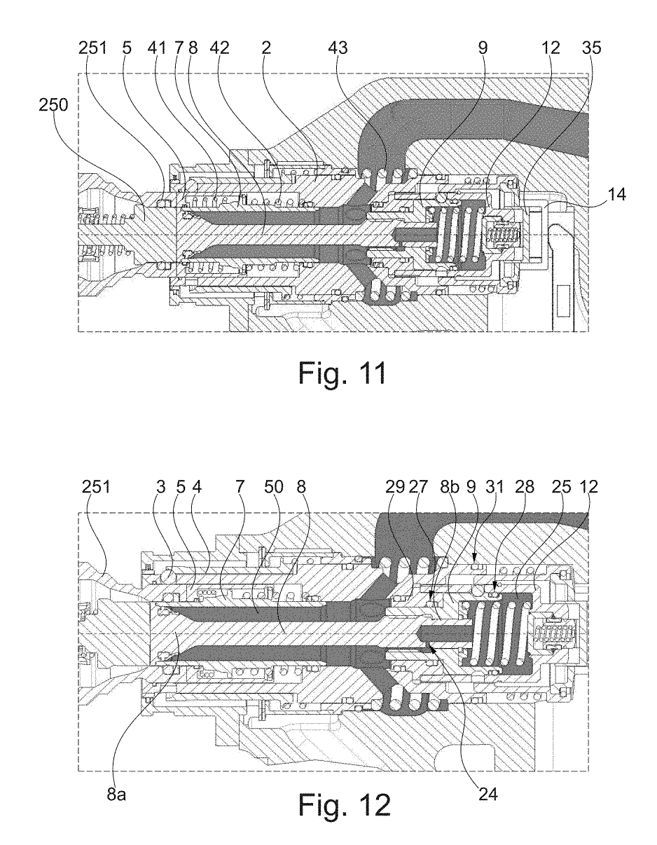

The connection step where there is pressurized fluid in the female cartridge will now instead be analyzed. Reference is made to FIG. 11, where the condition is seen in which the front faces of the male 250 and female 8 valve bodies are already in contact.

The valve body 250 of the male coupling comes into contact with the valve body 8 of the female cartridge 1 and the main body 251 of the male coupling simultaneously comes into contact with the outer slider 5 of cartridge 1.

With reference to FIG. 12, in a first connection step, the main body 251 of the male coupling pushes the outer slider 5 into contact with the inner slider 7.

Due to the presence of a calibrated radial discharge hole 24 on the rear end 8b of the valve body 8 of cartridge 1, the pressurized fluid involving the cartridge also fills the decompression chamber 25 formed, as mentioned, between the components: valve body 8, inner body 9, rear body 12 and seat 26 of the decompression valve 33.

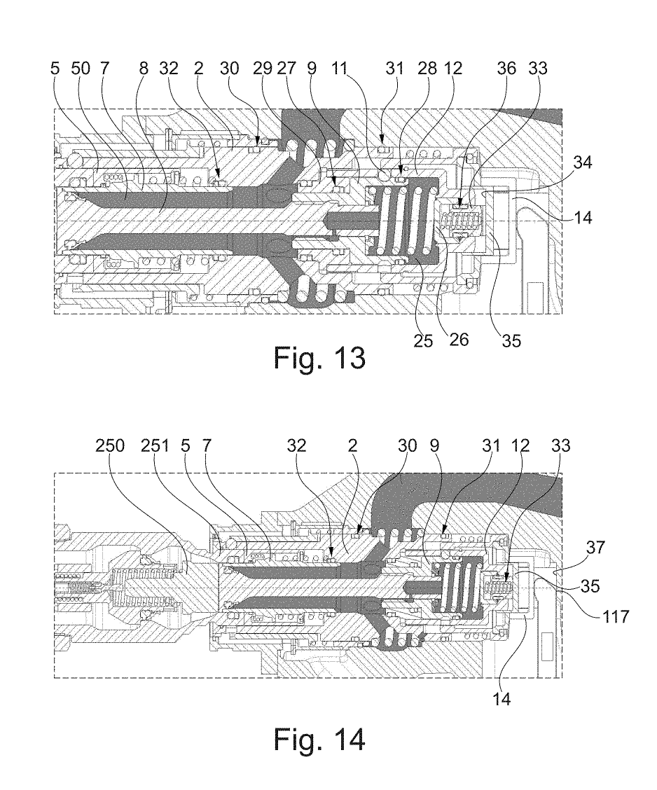

With reference to FIG. 13, the ball body 2 is hydraulically balanced under this condition, because the pressure of the fluid acts on the first sealing gasket 30 and on the second sealing gasket 31 of said ball body 2, which are specifically provided on the outer surface of said ball body 2, which operate on identical diameters.

Thus, the ball body 2 remains stopped in the initial position thereof, also in the presence of pressure in the cartridge. Moreover, the pressure of the fluid in the main chamber 50 acts on the first sealing gasket 27 of said inner body 9 interposed between said inner body 9 and a spacer 29, which is interposed between said inner body 9 and said ball body 2, while the pressure in the decompression chamber 25 acts on the second sealing gasket 28 of said inner body 9 interposed between said inner body 9 and said rear body 12.

The two gaskets are arranged at different diameters, more specifically the inner body 9 having a front portion with smaller outer diameter and a rear portion with larger outer diameter, as clearly shown in FIG. 13.

Thus, the first 27 and second 28 gaskets of said inner body 9 act on different diameters, which creates a hydraulic unbalance which keeps the assembly of components comprising the valve body 8 and the inner body 9 pushed forward against spacer 29, which in turn is locked between the ball body 2 and the rear body 12.

With reference to FIG. 14, the successive connection step is now described.

The movement of the ball body 2 is made possible because the first 30 and the second 31 sealing gaskets of the ball body 2 act on the same diameter, as mentioned, thus eliminating the push due to the pressure.

The inner slider 7 is kept pushed forward against the valve body 8 by the pressure which acts on the first gasket of the ball body 32 and on the second gasket of the ball body 19, which are hydraulically unbalanced.

The valve body 8 and the inner body 9 are also pushed at the front to come into contact on spacer 29, which in turn is locked between said ball body 2 and said rear body 12.

Thus, as long as there is pressurized fluid in the cartridge, the inner body 9, the rear body 12, spacer 29, the valve body 8, the seat of the decompression valve 26 and the inner slider 7 are locked with respect to the ball body 2.

The main body 251 of the male coupling 200 pushes the outer slider 5 of cartridge 1, which in turn pushes the aforesaid assembly of components into the withdrawn position up to bringing the decompression valve 33 into contact against the inner abutment surface 34 of pusher 35.

As will be better described below, pusher 35 is a substantially cylindrical member in which said rear body 12 is inserted, and which projects toward the rear area of the cartridge, interposing between said decompression valve 33 and said cam 310 of said lever 300.

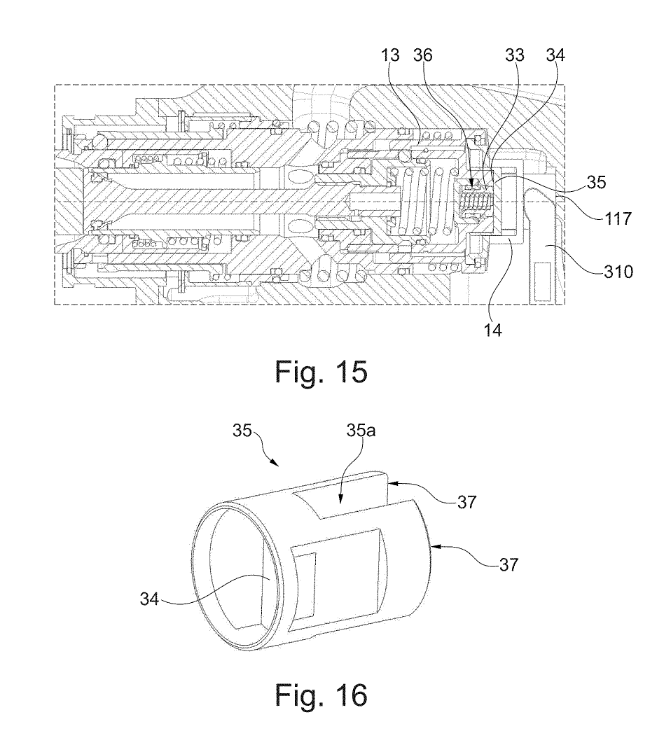

With reference to FIG. 15, continuing in the connection travel of the male coupling into the female cartridge 1, it is worth noting how the decompression valve 33 opens the passageway of the oil between the interior of the cartridge and a rear area of the cartridge itself, thereby discharging the pressure. Indeed, it is worth noting that the decompression valve 33 is kept in position by the inner abutment surface 34 of pusher 35, while the rear body 12 continues to be pushed forward with the seat of the decompression valve 26, until gasket 36 of the decompression valve 33 is no longer at the inner surface of seat 26 and therefore it no longer exerts the fluid seal, thus allowing the discharge of the pressurized oil.

Gasket 36 of the decompression valve 33 operates on two identical diameters, which makes possible the operation of opening the pressure discharge valve with the least effort possible. Moreover, pusher 35 has an inner surface 37, which rests on the inner abutment surface 117 of block 100.

FIG. 16 shows a perspective view of pusher 35 alone, in which it is worth noting the abutment surface 34 for the decompression valve 33 and the rear outer surface 37, which is in contact with the abutment surface 117 of block 100. In order to allow cam 310 to actuate the rear body 12, pusher 35 is conveniently shaped so as to have a longitudinal groove 35a of sufficient dimensions to allow the insertion of cam 310 into said groove.

Once the pressure inside the female cartridge 1 is eliminated, the connection continues as described above in the event of connection with no pressure.

At the end of the connection, the decompression valve 33 closes the passageway of the fluid toward the rear area again due to the push of the return spring 38 of the decompression valve 33, which acts between said seat of the decompression valve 26 and the inner surface of said valve.

The mechanical locking system is not disengaged during the connection procedure described above.

Now the disconnection step will be analyzed to understand the operation of the lever decompression system of the cartridge.

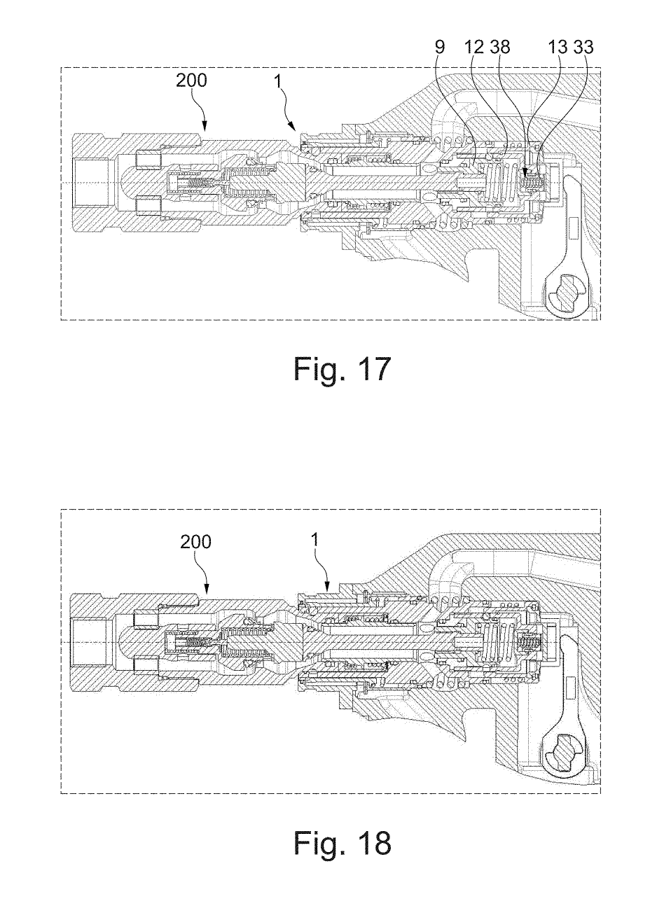

Reference is made to FIG. 17, which shows a condition of connection made: the male coupling is inserted in the female cartridge and the coupling and cartridge valves are open.

Due to the configuration of cartridge 1 in accordance with the present invention, it is provided with pull function, thus if there is no pressurized fluid in the circuit, and therefore in the couplings, it is sufficient to pull the male coupling to obtain the disconnection.

The case is instead different in which there is pressurized fluid in the circuit. In such a case, there is a need to act in advance on lever 300 to discharge the pressure in order to succeed in disconnecting the male coupling from the female cartridge.

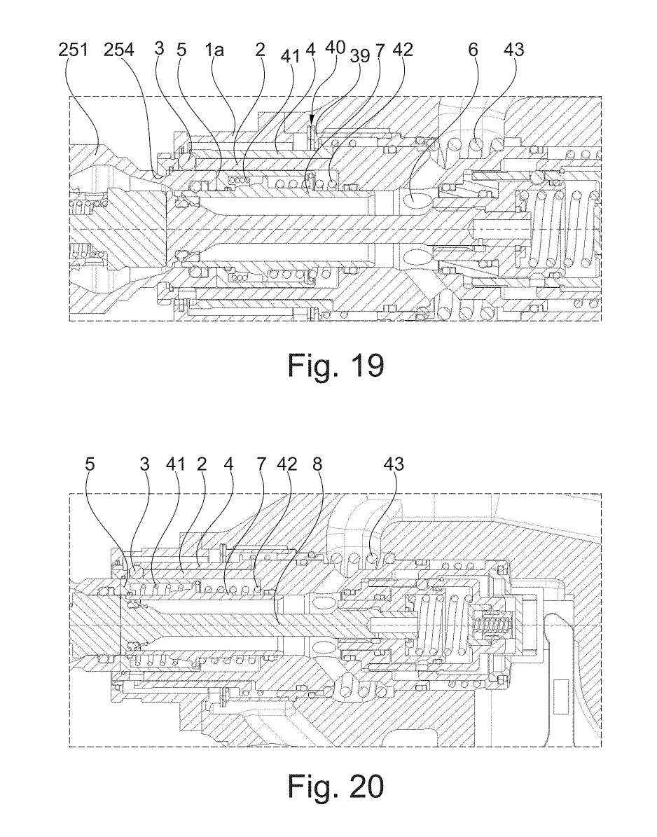

FIG. 18 depicts cartridge 1 in accordance with the present invention, connected to the male coupling in the absence of pressure. FIG. 19 shows a first disconnection step which occurs simply by pulling the male coupling away from the cartridge. The main body 251 of the male coupling 200 is pulled outwardly, the locking balls 3 initially locked between the circumferential locking groove 254 obtained on the outer surface by the main body 251 of the male coupling 200 transmit the translation motion of the male coupling 200 also to the ball body 2 of the female cartridge 1. The ball body 2 is therefore in an advanced position with respect to the normal resting position, as shown in FIG. 19. The ring nut slider 4 remains stopped, resting on the outer body 39 of the cartridge, which is in turn locked in block 100 by the elastic ring 40.

The locking balls 3 are now disengaged because the ring nut slider 4 no longer prevents the radial expansion thereof, and they may therefore come out of the circumferential seat 254.

The circumstance shown in FIG. 20 shows the male coupling already disconnected from the female cartridge. The helical springs reposition the components of the cartridge, in particular: a first spring 41 acting between said outer slider 5 and said inner slider 7, repositions the outer slider 8; a second spring 42 acting between said inner slider 7 and said ball body 2, repositions the inner slider 7; and a third spring 43 acting between said ball body 2 and said block 100, repositions the ball body 2.

At this point, the ball body 2, inner slider 7 and outer slider 8 components are in the initial position thereof of disconnected cartridge.

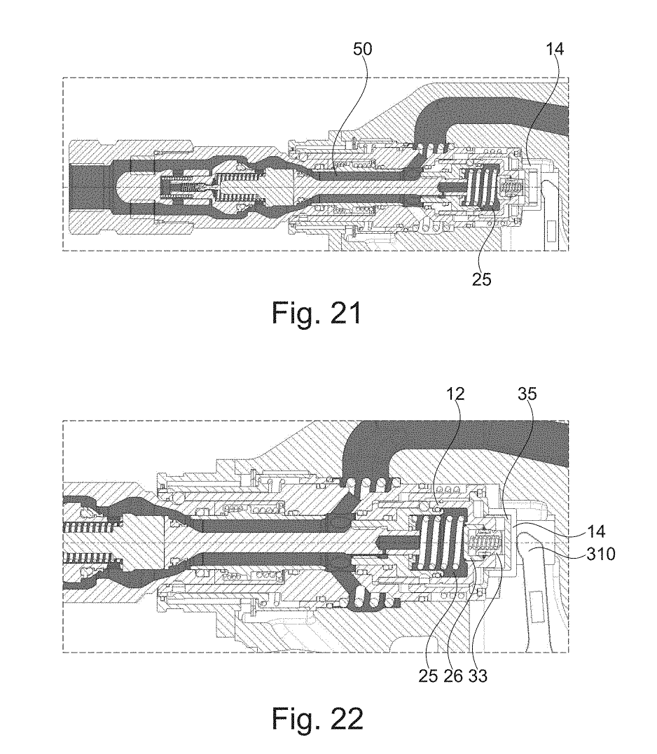

With reference to FIG. 21, the disconnection step is now described when there is pressurized fluid in the circuit.

Under the normal operating condition, there is also pressurized fluid in the decompression chamber 25. The operator acts on lever 300 thus obtaining the rotation of cam 310, which pushes the rear abutment 14 into the advanced position up to the inner surface 14a of the rear abutment 14 facing toward the front part of the cartridge coming into contact with the outer surface 35a of pusher 35 facing toward the rear part of the cartridge.

The rear slider 13 is simultaneously also pushed into the advanced position, because as mentioned, the rear abutment 14 is constrained to the rear slider 13 by means of the elastic ring 15.

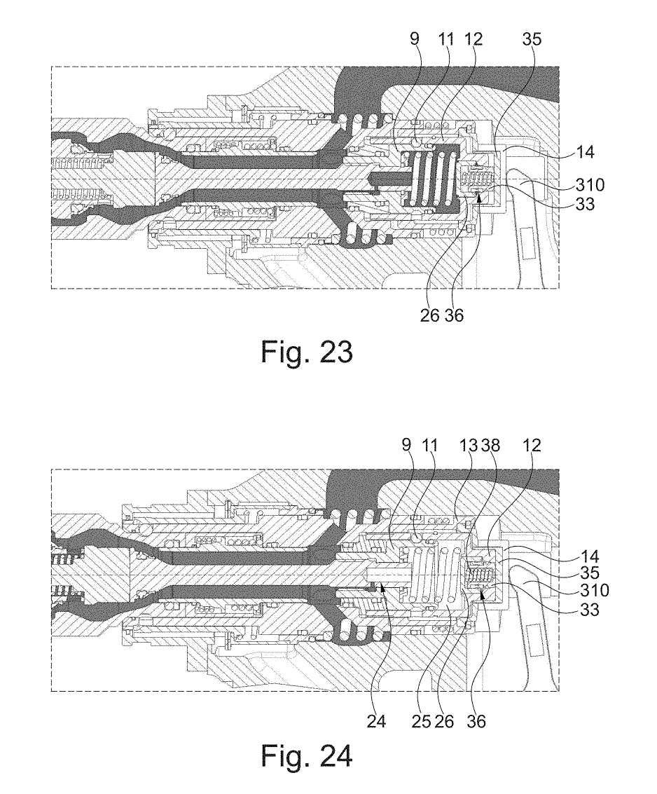

FIG. 23 shows a successive step of the actuation of the depressurization device: by continuing to actuate lever 300, cam 310 continues to push the rear abutment 14 and pusher 35 forward, that is toward the front part of the coupling, thus coming into contact with the decompression valve 33. The decompression valve 33 is compressed, thus discharging the pressure of the fluid in the decompression chamber 25, as shown in FIG. 24.

In this step, the pressure in the main conduit also remains for a short instant due to the calibrated radial discharge hole 24 on the rear end 8b of the valve body 8.

In this step, pusher 35 comes into contact with the rear body 12.

The mechanical locking balls 11 of the decompression system of cartridge 1 are no longer kept in the locking position thereof by the rear slider 13, and thus may come out of the circumferential seat 10 provided on the inner body 9, thus disengaging the inner body 9 itself from the rear body 12.

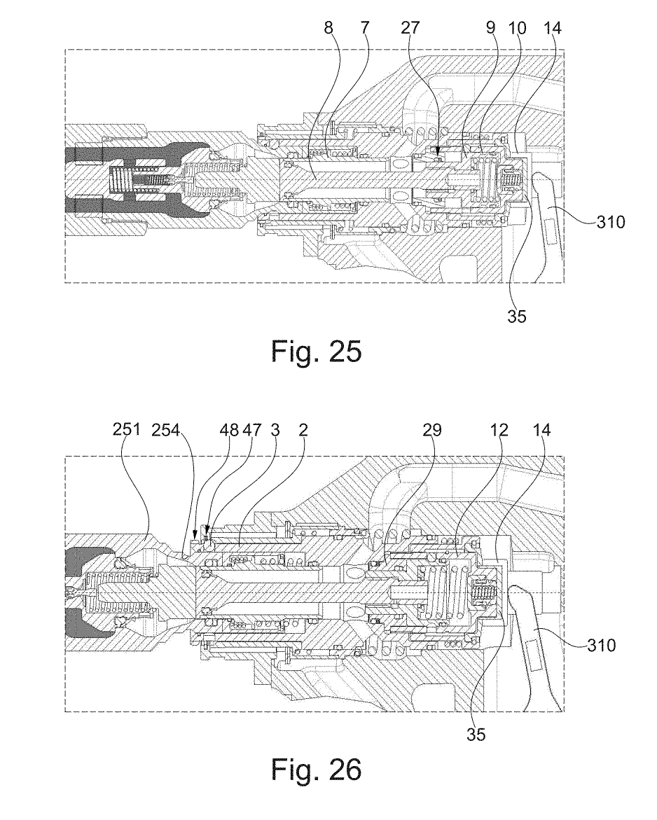

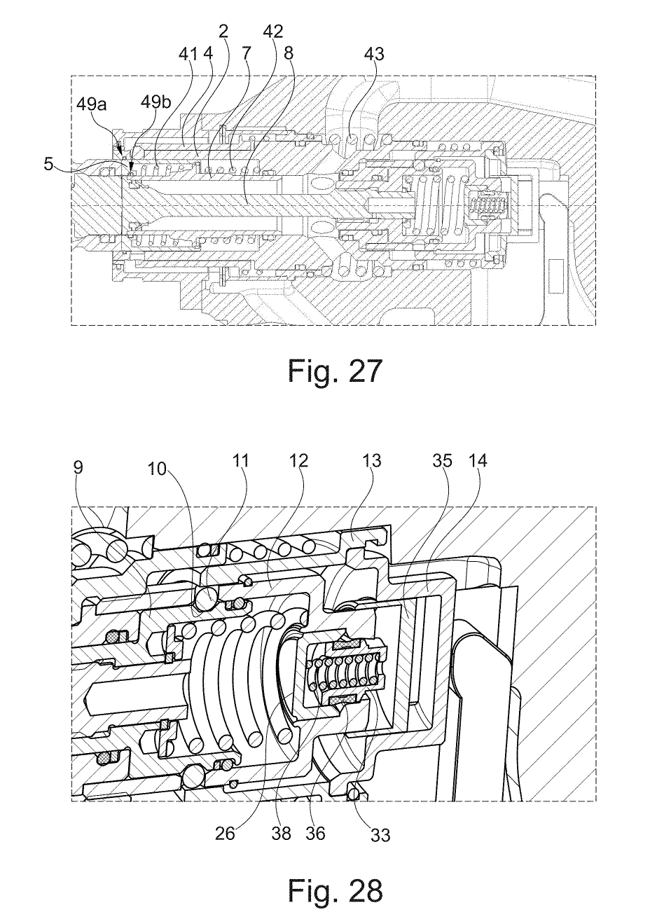

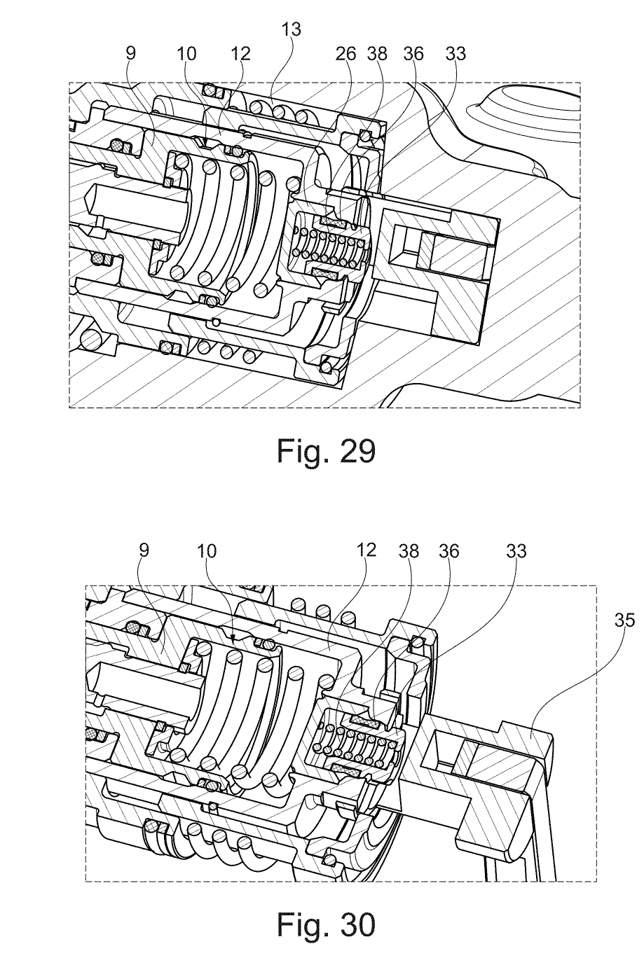

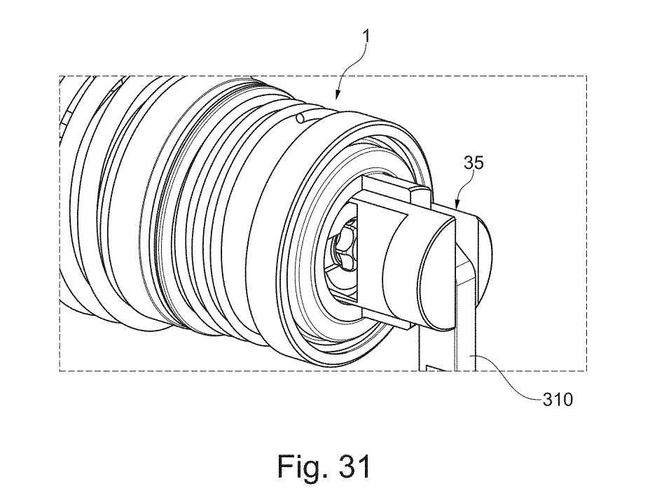

With particular reference to FIG. 25, it is worth noting how by acting on the first sealing gasket 27 of said inner body 9, the pressure in the main channel of the cartridge pushes the inner body 9 and valve body 8 components into the withdrawn position up to resting the valve body 8 against the inner slider 7.

Thereby, the inner valves of the male coupling close, trapping the pressurized fluid in the male coupling itself.

By continuing to actuate the lever, the rear abutment 14, pusher 35, the rear body 12, spacer 29, the ball body 2 move outwardly up to disengaging the locking balls 3 from the circumferential seat 254 of the main body 251 of the male coupling. The circumstance is depicted in FIG. 26.

FIG. 28 shows the male coupling and the female cartridge 1 in disconnected step. Similarly to what occurs in the event of disconnection in the absence of pressure, the first 41, the second 42 and the third 43 helical springs reposition the ball body 2, outer slider 5 the inner slider 7 components in the initial position.

Advantageously, a securing flange 1a containing a front gasket 47 is connected to the front abutment 48 assembled on the ball body 2, with function of dirt guard and of securing to the support block 100.

Moreover, a first gasket 49a of the outer slider 5 operates between said outer slider 5 and said ball body 2, and a second gasket 49b of the inner slider 7 operates between said ball body 2 and said inner slider 7.

Drawings 28 to 31 show three-dimensional views of the detail of the decompression system of cartridge 1 in accordance with the present invention, as already described above.

It has thus been shown how the integrated flush-face female cartridge 1 in accordance with the present invention allows the task and objects to be resolved by the invention.

In particular, the integrated flush-face female cartridge 1 in accordance with the present invention can be coupled with any type of Standard ISO 16028-compliant flush-face male coupling.

Moreover, the cartridge in accordance with the present invention is provided with a system for discharging the pressure which allows connection and disconnection, also with residual pressure.

The cartridge in accordance with the present invention is also provided with a mechanical lock for locking the decompression system in the coupling step, with the possibility of release by actuating the pressure discharge lever.

Again, the mechanical lock system with which the integrated flush-face female cartridge in accordance with the present invention is provided, allows the male coupling to be disconnected also in the presence of pressurized fluid in the circuit.

1. A female cartridge which is insertable into a support block, comprising an outer ring nut slider and a ball body provided with a plurality of radial holes for inletting the fluid into the cartridge, said outer ring nut slider being axially movable with respect to said ball body, which in turn comprises a circumferential housing seat for a locking ball ring, said cartridge further comprising an outer slider, an axial valve body, and an inner slider interposed between said valve body and said outer slider, said outer slider being axially movable relative to said inner slider, which in turn is axially movable with respect to said ball body, said outer slider being configured so as to keep said locking balls within said circumferential housing seat of said ball body when the cartridge is uncoupled, said axial valve body, said outer slider and the front end of said valve body being aligned along the front surface of the female cartridge so that said female cartridge coupling is capable of being coupled to a flush-face male coupling.

2. The female cartridge according to the preceding claim, wherein said valve body comprises a rear end to which an inner body is connected, which is at least partly inserted into a rear body, said inner body having at least one circumferential seat adapted to house a plurality of mechanical locking balls of the system of said cartridge and said rear body comprising a plurality of radial holes for inserting said mechanical locking balls.

3. The female cartridge according to the preceding claim, wherein it further comprises a rear slider slidingly associated externally with said rear body and configured to cooperate with said mechanical locking balls, said rear slider being movable between a first position in which it keeps said locking balls inside said circumferential seat of said inner body, and a second position in which it leaves said locking balls free to radially expand, thus disengaging the inner body.

4. The female cartridge according to the preceding claim, wherein it further comprises a decompression chamber and a decompression valve defined inside said rear body and said inner body, said decompression valve being housed in a housing seat defined inside said decompression chamber.

5. The female cartridge according to the preceding claim, wherein said rear slider is associated with a rear abutment which projects at the back from the cartridge thus abutting, with cartridge inserted, against a cam of a disconnecting lever which can be operated by the user, said rear abutment being kept in the withdrawn position by the action of a helical spring acting between said rear slider and said ball body up to the contact of said rear with said cam.

6. The female cartridge according to the preceding claim, wherein it further comprises a spacer interposed between said inner and said ball body and in that it comprises a first sealing gasket of said inner body interposed between said inner body and said spacer, and a second sealing gasket of said inner body interposed between said inner body and said rear body, said inner body having a front portion with smaller outer diameter and a rear portion with larger outer diameter, so that said first sealing gasket and second sealing gasket of said inner body therefore act on different diameters, thus creating a hydraulic unbalance.

7. The female cartridge according to the preceding claim, wherein it further comprises a pusher which is substantially cylindrical in shape, within which at least one portion of said rear body is slidingly inserted and which comprises a rear outer surface which comes into contact with the inner abutment surface of said support block.

8. The female cartridge according to the preceding claim, wherein said pusher comprises a longitudinal groove adapted to allow the insertion of said cam into said groove.

9. The female cartridge according to the preceding claim, wherein it further comprises a flange connected to said ball body with function of dirt guard.

10. A system comprising a support block, wherein at least one female cartridge according to any one of claims 1 to 9 is inserted, said female cartridge being connectable to a Standard ISO 16028-compliant flush-face male coupling.
